(19) United States
(12) Patent Application Publication
(10) Pub. No.: US 2012/0089524 A1
(43) Pub. Date: Apr. 12, 2012

(54) SYSTEM AND METHOD FOR RECEIVING, STORING, AND TRANSMITTING PATENT-RELATED INFORMATION

(76) Inventor: Stuart Andrew Nelson, Minnetonka, MN (US)

(21) Appl. No.: 13/243,403

(22) Filed: Sep. 23, 2011

Related U.S. Application Data
(60) Provisional application No. 61/391,957, filed on Oct. 11, 2010.

(51) Int. Cl. G06Q 50/00

(52) U.S. Cl. 705/310

(57) ABSTRACT

A method for receiving, storing, and transmitting patent-related information includes receiving, from a plurality of sources, identifying information that at least partially identifies patent invalidity information for a plurality of patents, storing the identifying information in a database, receiving a request from a third party to transmit at least a portion of the identifying information over the internet, and transmitting the requested portion of the identifying information over the internet, in a format suitable to be displayed as a website, to the third party in response to the request.

### CROSS-REFERENCE TO RELATED APPLICATIONS

This application claims priority to U.S. Provisional Patent Application No. 61/391,957 filed on Oct. 11, 2010 and entitled “SYSTEM AND METHOD FOR RECEIVING, STORING, AND TRANSMITTING PATENT-RELATED INFORMATION,” the disclosure of which is hereby incorporated by reference in its entirety.

### BACKGROUND

The present invention relates to patent-related information, and in particular, to the collection and distribution of patent-related information.

When a patent applicant desires to patent an idea, the applicant submits a patent application to a regional or national patent office, such as the United States Patent and Trademark Office (USPTO). An examiner at the USPTO will review the application, search relevant prior art, and determine whether the application claims any patentable matter. If the examiner determines that one or more claims are allowable, the applicant will be granted a patent upon payment of certain requisite fees.

Even after a patent is granted, the patent may nevertheless be legally invalid for one or more reasons. For example, in the United States, 35 U.S.C. §102(b) currently states that a patent is invalid if “the invention was patented or described in a printed publication in this or a foreign country or in public use or on sale in this country, more than one year prior to the date of the application for patent in the United States.” Though the examiner has searched for prior art and was unable to find an anticipating reference, it is not possible for an examiner to identify and search all possible prior art in existence. Consequently, patents are granted even though invalidating prior art does exist.

Because of this, businesses and other entities periodically search for prior art for certain patents in order to invalidate those patents. Often an attorney will prepare an invalidity opinion stating a legal conclusion that a given patent is invalid as anticipated or rendered obvious by one or more references. An invalidity opinion can be informal, but will often be a formal document that was time consuming and expensive to create. If a second entity desires an invalidity opinion for the same patent, the second entity would have to repeat the same time consuming and expensive process.

### SUMMARY

The present invention includes a method for receiving, storing, and transmitting patent-related information. The method includes receiving, from a plurality of sources, identifying information that at least partially identifies patent invalidity information for a plurality of patents, storing the identifying information in a database, receiving a request from a third party to transmit at least a portion of the identifying information over the internet, and transmitting the requested portion of the identifying information over the internet, in a format suitable to be displayed as a website, to the third party in response to the request.

Another embodiment of the present invention is a method for receiving, storing, and transmitting patent-related information. The method includes receiving first identifying information from a first party having first patent invalidity information, wherein the first identifying information at least partially identifies the first patent invalidity information, receiving second identifying information from a second party having second patent invalidity information, wherein the second identifying information at least partially identifies the second patent invalidity information, storing the first and second identifying information in a database, receiving a request from a third party for at least one of the first and second identifying information; and transmitting, via a computer, at least one of the first and second identifying information in response to the request from the third party.

Another embodiment of the present invention is a system for receiving, storing, and transmitting patent-related information. The system includes means for receiving first identifying information from a first party having first patent invalidity information, wherein the first identifying information at least partially identifies the first patent invalidity information and means for receiving second identifying information from a second party having second patent invalidity information, wherein the second identifying information at least partially identifies the second patent invalidity information. The system further includes means for storing the first and second identifying information in a database and means for transmitting at least one of the first and second identifying information in response to a request from a third party for at least one of the first and second identifying information.

Another embodiment of the present invention is one or more computer storage media having computer-executable instructions embodied thereon, that when executed, cause a computing device to perform a method for receiving, storing, and transmitting patent-related information in a database. The method includes receiving first identifying information from a first party having first patent invalidity information, wherein the first identifying information at least partially identifies the first patent invalidity information, receiving second identifying information from a second party having second patent invalidity information, wherein the second identifying information at least partially identifies the second patent invalidity information, storing the first and second identifying information in a database, receiving a request from a third party for at least one of the first and second identifying information, and transmitting at least one of the first and second identifying information in response to the request from the third party.

Another embodiment of the present invention is a system for receiving, storing, and transmitting patent-related information including at least one computer storage media and at lest one processor. The at least one computer storage media is operable to store first identifying information from a first party having first patent invalidity information and to store second identifying information from a second party having second patent invalidity information. The first identifying information at least partially identifies the first patent invalidity information, and the second identifying information at least partially identifies the second patent invalidity information. The at least one processor is operable to receive a request from a third party for at least one of the first and second identifying information and to transmit at least one of the first and second identifying information to the third party in response to the request.

Another embodiment of the present invention is a method for displaying patent-related information on a website. The method includes collecting, from a plurality of sources, identifying information that at least partially identifies patent invalidity information for a plurality of patents, receiving a request from a third party to view at least a portion of the identifying information over the internet, and transmitting a website including the requested portion of the identifying information to be displayed by a computer of the third party.

Another embodiment of the present invention is a method for a first party to transmit and store patent-related information in a database. The method includes transmitting, via a computer, identifying information to a host party to be stored in a database and displayed on a website, wherein the identifying information at least partially identifies patent invalidity information, transmitting contact information to the host party, wherein the contact information allows the host party to contact the first party, receiving a request to transmit the patent invalidity information, and transmitting the patent invalidity information either to the host party or to a third party in response to the request to transmit the patent invalidity information.

Another embodiment of the present invention is a method for a party to obtain patent-related information. The method includes transmitting to a host party, via a computer, a request for identifying information that at least partially identifies patent invalidity information for a particular patent, receiving from the host party, via the computer, a website including the identifying information, displaying, via the computer, the website including the identifying information, viewing the identifying information, and transmitting to the host party, via the computer, a request to purchase the patent invalidity information, wherein the patent invalidity information is owned by a party other than the host party.

### BRIEF DESCRIPTION OF THE DRAWINGS

FIG. 1 is a schematic view of a system for receiving, storing, and transmitting patent-related information.

FIG. 2 is a website displayed on a browser by a computer.

FIG. 3 is a block diagram of a method for receiving, storing, and transmitting patent-related information.

### DETAILED DESCRIPTION

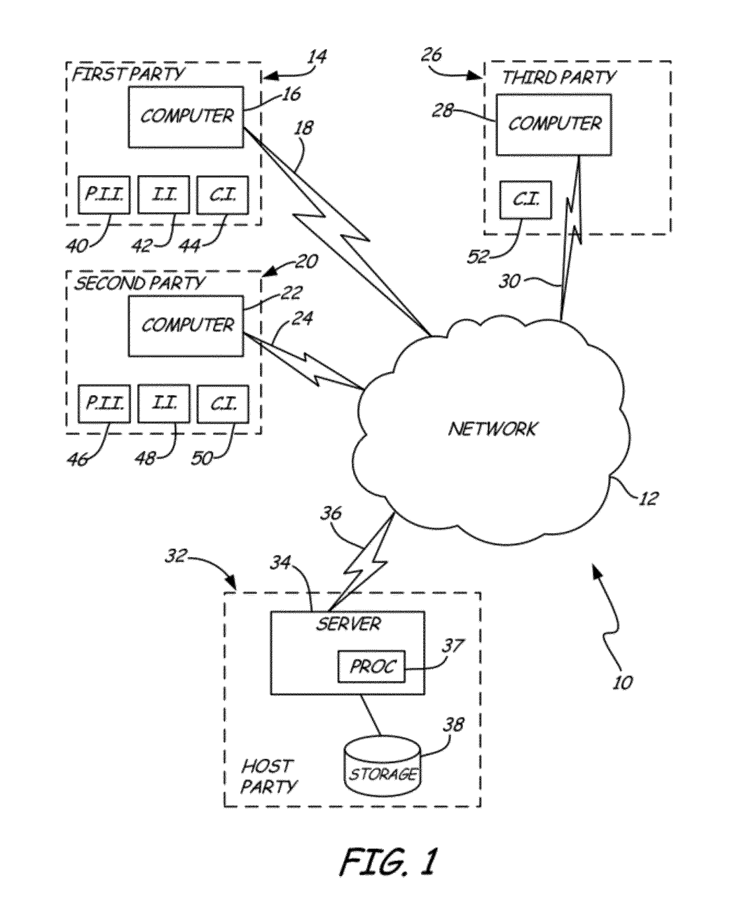

FIG. 1 is a schematic view of system 10 for receiving, storing, and transmitting patent-related information. System 10 includes network 12 connected to first party 14 via first computer 16 over first communication link 18, second party 20 via second computer 22 over second communication link 24, third party 26 via third computer 28 over third communication link 30, and host party 32 via server 34 over fourth communication link 36. Server 34 includes processor 37 and is connected to one or more computer storage media 38.

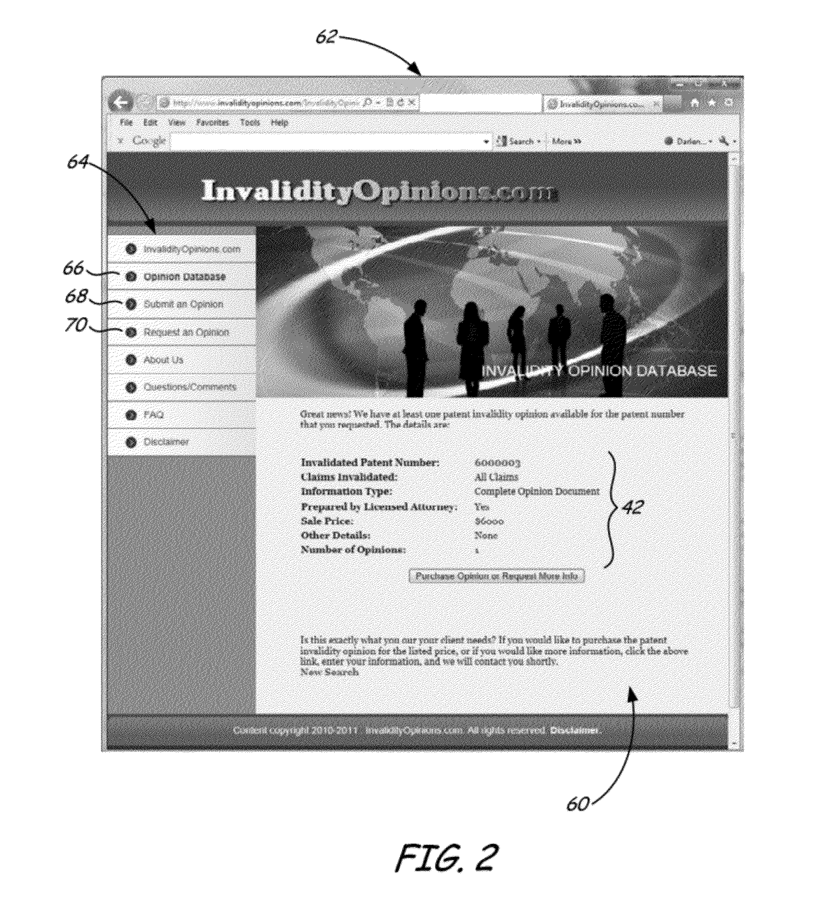

First, second, and third computers 16, 22, and 28 can communicate over network 12, such as the Internet or other network. First, second, and third computers 16, 22, and 28 can communicate over network 12 via a suitable browser, such as Internet Explorer (shown in FIG. 2), Netscape Navigator, Mozilla Firefox, Opera, or Google Chrome. First, second, and third computers 16, 22, and 28 can be a laptop computer, a computer workstation, a personal computer, a personal digital assistant, a cellular phone, a mobile phone, a smart phone, another telephone, a digital tablet, an internet appliance, or virtually any device suitable for communicating over network 12 with host party 32. First, second, third, and fourth communication links 18, 24, 30, and 36 can be virtually any combination of wired and/or wireless communication mechanisms suitable for communicating over network 12, such as Bluetooth, WiMax, 802.11a, 802.11b, 802.11g, 802.11n, a proprietary communications network, infrared, optical, or a public switched telephone network.

Host party 32 is an operator of a website (shown in FIG. 2), hosted on server 34. Server 34 is connected to computer storage media 38, which contains data displayed on the website, including one or more databases of patent-related information. The website can be displayed to a user accessing the website on a computer monitor, or other display. The website can be one of various formats, such as HTML, XML, or XHTML. Computer storage media 38 can be an electronic, optical, magnetic, or other storage or transmission device capable of providing a computer, such as server 34, with computer-readable instructions, such as a floppy disk, CD-ROM, DVD, magnetic disk, memory chip, ROM, RAM, an ASIC, a configured processor, magnetic tape, or any other media from which a computer can read instructions. The instructions may comprise code from any suitable computer-programming language, such as C, C++, C#, Visual Basic, Java, Python, Perl, or JavaScript.

First party 14 and second party 20 are entities that each have patent-related information. First party 14 and second party 20 can have the same patent-related information, different patent-related information, or some same and some different patent-related information. The patent-related information of first party 14 includes first patent invalidity information 40, first identifying information 42, and first contact information 44. The patent-related information of second party 20 includes second patent invalidity information 46, second identifying information 48, and second contact information 50.

First and second patent invalidity information 40 and 46 can be one or more physical documents (e.g. paper documents), electronic documents (e.g. PDF, TIFF, DOC, WPD, TXT, or other document file formats), or the like, that identify at least one claim of one or more patents as being invalid, expired, or otherwise unenforceable for any reason. First and second patent invalidity information 40 and 46 can be one or more formal invalidity opinions (also referred to as “validity opinions” or “freedom to operate opinions”) prepared by a licensed attorney, or can be less formal invalidity information, such as a simple identification of a patent and a reason for invalidity. In cases where a party is concerned about waiver of attorney-client privilege attached to a formal invalidity opinion, that party can elect to disclose less than the full formal invalidity opinion.

The first and second patent invalidity information 40 and 46 can be based on any legal ground of invalidity, expiration, or unenforceability. For example, United States patents can be determined to be invalid, expired, or unenforceable for failing to satisfy 35 U.S.C. §101, 102, 103, 112, any other requirement found in any section of 35 U.S.C., any requirement set forth by case law, or any requirement found elsewhere in the law. The first and second patent invalidity information 40 and 46 can be based on laws presently in existence or based on new laws that go in effect in the future. Patents in other jurisdictions may be deemed legally invalid, expired, or unenforceable in that jurisdiction for other reasons. The first and second patent invalidity information 40 and 46 can be strictly focused on invalidity or can include other information, such as an analysis of claim scope and/or non-infringement of one or more patents.

The first and second identifying information 42 and 48 can be sufficient to at least partially identify the first and second patent invalidity information 40 and 46, respectively, without revealing the specific contents of the respective patent invalidity information. For example, first identifying information 42 can include some or all of the following to identify first patent invalidity information 40: number of the patent in question, title of the patent in question, whether some or all of the claims are invalidated, whether first patent invalidity information 40 is a complete opinion document or something less than a complete opinion, whether first patent invalidity information 40 was prepared by a licensed attorney, a price for which first party 14 would be willing to share first patent invalidity information 40, and/or other details.

The first and second contact information 44 and 50 can provide sufficient information to contact first and second parties 14 and 20, respectively. Similarly, third party 26 has third contact information 52 which can provide sufficient information to contact third party 26. For example, first contact information 44 can include some or all of the following: company name of first party 14, name of a contact person, a mailing address, an email address, a phone number, and/or other details. First contact information 44 can directly identify first party 14, or can identify an agent of first party 14, while maintaining the actual identity of first party 14 confidential.

Third party 26 may desire and be willing to pay for patent invalidity information for one or more patents, but may be unaware of who, if anyone, has patent invalidity information for the relevant patents. Moreover, third party 26 may not want anyone to know that it seeks patent invalidity information for the relevant patents. First and second parties 14 and 20 may be willing to share their respective first and second patent invalidity information 40 and 46 for a price, but may be unaware of who, if anyone, desires their respective first and second patent invalidity information 40 and 46. Moreover, first and second parties 14 and 20 may be reluctant to let it be publically known that they have their respective first and second patent invalidity information 40 and 46 and may be reluctant to share their respective first and second patent invalidity information 40 and 46 with certain other parties, such as an owner of the patent in question.

Host party 32 can use its website and corresponding databases to act as an intermediary that allows first, second, and third parties 14, 20, and 26 to share and view certain information (e.g. first and second identifying information 42 and 48) while limiting access to other information (e.g. first and second patent invalidity information 40 and 46 and first, second, and third contact information 44, 50, and 52).

FIG. 2 is one embodiment of website 60 displayed on browser 62 by a computer, such as first computer 16, second computer 22, or third computer 28 (shown in FIG. 1). In the illustrated embodiment, browser 62 is Internet Explorer. Website 60 includes clickable links 64 for displaying various pages in website 60. Links 64 include Opinion Database link 66, Submit an Opinion link 68, and Request an Opinion link 70. Website 60 is illustrated as displaying first identifying information 42. In alternative embodiments, website 60 can have a layout and contain links 64 that are different from the illustrated embodiment.

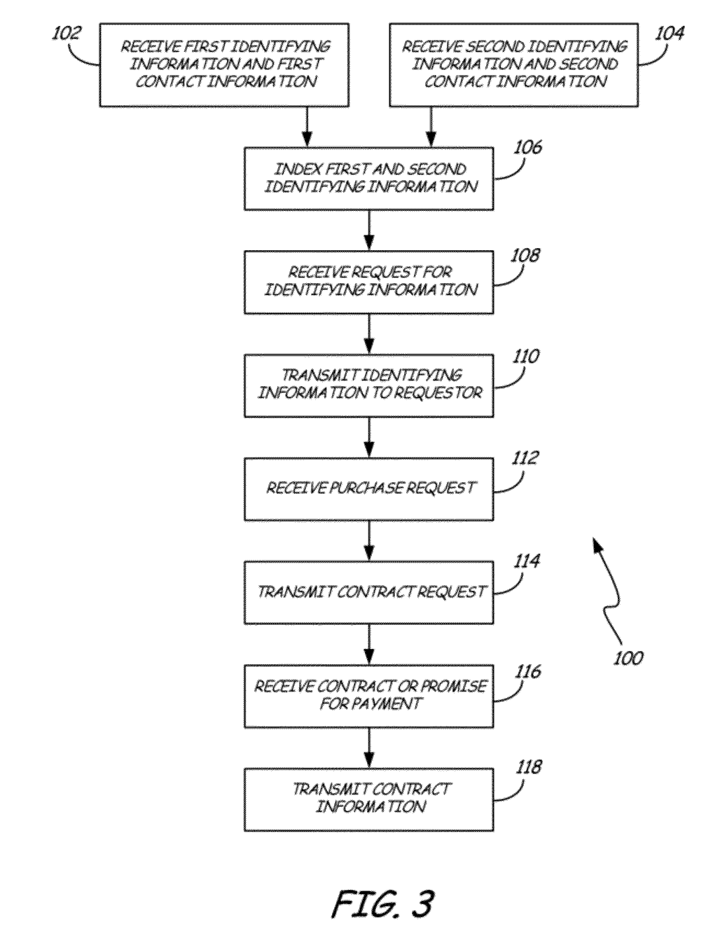

FIG. 3 is a block diagram of method 100 for receiving, storing, and transmitting patent-related information. At step 102, host party 32 receives first identifying information 42 and first contact information 44 from first party 14. First identifying information 42 identifies first patent invalidity information 40, but first party 14 does not actually transmit first patent invalidity information 40 and instead keeps it as confidential. At step 104, host party 32 receives second identifying information 48 and second contact information 50 from second party 20. Second identifying information 48 identifies second patent invalidity information 46, but second party 20 does not actually transmit second patent invalidity information 46 and instead keeps it as confidential. At step 106, host party 32 stores first and second identifying information 42 and 48 in an electronic database which will be referred to as an invalidity database. First and second identifying information 42 and 48 can be indexed in the invalidity database by patent number, by first and second contact information 44 and 50, or both. Host party 32 may also store first and second contact information 44 and 50 in a confidential portion of the invalidity database or in a separate contact information database. Each database could be a formal complex database or may be a simpler database, such as a table, list, or spreadsheet that contains the relevant information in a suitable manner. First and second contact information 44 and 50 are kept confidential by host party 32 absent agreement by first party 14 or second party 20 to release their respective contact information. First and second identifying information 42 and 48 are publicly available upon request. At step 108, host party 32 receives a request from third party 26 for at least one of first and second identifying information 42 and 48. The request can be for information related to a specific patent, for information related to a category of patents, or for information contained in the invalidity database in general. The request can be one for information related to one or more specific patents, though not necessarily specifically seeking invalidity information. At step 110, host party 32 transmits at least one of first and second identifying information 42 and 48 to third party 26 in response to the request. Host party 32 can transmit the at least one of the first and second identifying information 42 and 48 over network 12 in a format suitable to be displayed on a monitor of third computer 28 as a website, such as website 60 (shown in FIG. 2). Host party 32 can transmit identifying information specific to a particular patent, a larger portion of the information in the invalidity database, or the entire invalidity database, less any confidential information.

Third party 26 can then review first identifying information 42, which identifies first patent invalidity information 40, and determine whether it wishes to purchase first patent invalidity information 40. At step 112, third party 26 transmits a purchase request, which host party 32 receives, to purchase first patent invalidity information 40. The purchase request can include third contact information 52 if host party 32 does not already have it. The purchase request can be a non-binding request to negotiate or can be a formal offer to form a contract.

At some point prior to putting first party 14 and third party 26 in contact with one-another, host party 32 may desire payment for its services or a legal commitment for payment. In the illustrated embodiment, at step 114, host party 32 then transmits a contract request to first party 14 and further informs first party 14 that there has been a request to purchase first patent invalidity information 40. The contact request can be an agreement to pay a percentage of the total purchase price for the sale of first patent invalidity information 40, contingent upon completion of the sale transaction. Such an agreement allows host party 32 to secure a legal right to payment, should a transaction ultimately be completed, while protecting first party 14 from having to pay a fee upfront or at any time if no transaction ultimately takes place. Alternatively, the contract can be for a fixed fee, can be non-contingent, or can have virtually any other payment structure suitable for the situation. In further alternative, host party 32 can transmit the contract request to third party 26, requesting payment or a promise of payment from third party 26. At step 116, host party 32 receives a signed contract, payment, or other promise for payment from first party 14 and/or third party 26. If host party 32 has already received payment or a promise of payment, or if host party 32 has a business model that renders direct payment unnecessary, steps 114 and 116 can be omitted. At step 118, host party 32 transmits third contact information 52 to first party 14 and/or first contact information 44 to third party 26.

First party 14 and third party 26 may then complete a transaction for sale of first patent invalidity information 40. The transaction may be conducted by agents, with the true party in interest being anonymous, or may include one or both of first party 14 and third party 26 revealing the identity of the true party in interest. The transaction can include an agreement to keep first patent invalidity information 40 confidential and not further disclose it to any other party, can include other restrictions on the use of first patent invalidity information 40, or can include no restrictions. Upon completion of the transaction, host party 32 receives compensation out of the purchase proceeds as a percentage of the purchase price, or as otherwise agreed upon.

Host party 32 can play little or no role in the actual negotiations over and transmission of first patent invalidity information 40. In that case, agents of first party 14 and third party 26 would negotiate directly on any necessary contract terms. Alternatively, host party 32 can continue to act as an intermediary. For example, host party 32 can receive first patent invalidity information 40 from first party 14 at step 102 and second patent invalidity information 46 at step 104. In that case, host party 32 can then transmit first patent invalidity information 40 directly to third party 26, receive payment from third party 26, and transmit an agreed upon portion of the payment to first party 14.

By having host party 32 receive first patent invalidity information 40 from first party 14 and transmit it to third party 26 only after third party 26 has remitted payment, step 118 can be omitted and first party 14 and third party 26 can remain anonymous from each other. Requiring third party 26 to pay host party 32 prior to receiving first patent invalidity information 40 also gives confidence to first party 14 that third party 26 will not be able to take first patent invalidity information 40 without paying.

Host party 32 can provided a further service by reviewing first patent invalidity information 40 to ensure it complies with one or more predetermined requirements. For example, third party 26 may agree to purchase first patent invalidity information 40 only if it identifies prior art that third party 26 has not already found. In addition, or alternatively, third party 26 may agree to purchase first patent invalidity information 40 only if it includes an argument for invalidity or unenforceability that has a sufficiently reasonable legal basis. Host party 32 can review first patent invalidity information 40 to determine if it meets these or other conditions agreed by the parties. Such a review can be performed manually or automatically by server 34. If one or more conditions are not met, the parties need not continue the transaction. Host party 32 will then return first patent invalidity information 40 to first party 14 and return the payment to third party 26. Thus, each of first party 14 and third party 26 can enter into such a transaction anonymously without fear that it will be swindled by the other.

In further alternative, first party 14 and third party 26 can employ another intermediary to review first patent invalidity information 40 and hold the payment unless certain conditions are met by first patent invalidity information 40. For example, the intermediary can be an attorney who regularly represents first party 14 or third party 26, a neutral attorney not associated with either party, or some combination of those attorneys. This allows first party 14 and third party 26 to select any intermediary whom they trust to hold payment and make determinations about first patent invalidity information 40. In that case, first party 14 and third party 26 would only need to trust host party 32 to protect first identifying information 42 and third identifying information 52, not any other information. Making it easy for parties to submit information to host party 32, helps host party 32 grow the invalidity database.

The invalidity database can function as a single location for referencing invalidity information prepared by a plurality of attorneys for a plurality of patents that have been deemed valid and in force by a plurality of patent offices in a plurality of countries. If first party 14 and second party 20 both have patent invalidity information identifying one or more of the same patents, host party 32 can inform third party 26 of that fact. Third party 26 can ultimately negotiate with first party 14, second party 20, or both.

Some or all of the steps of method 100 can be performed by a computer, such as server 34 and its processor 37, or by multiple computers. Computer storage media 38 can have computer-executable instructions embodied thereon, that when executed, causes server 34 to perform some or all of the steps of method 100.

First party 14 and second party 20 can be virtually any entities that have patent-related information, such as a business that manufactures products and produces or obtains invalidity opinions related to those products, a non-practicing entity, a patent attorney, or any individual or entity capable of obtaining patent invalidity information. Such entities may produce patent invalidity information themselves or may hire others to do so.

Host party 32 can supplement first and second identifying information 42 and 48 in the invalidity database with additional identifying information that identifies additional patent invalidity information. The additional patent invalidity information can be formal or informal invalidity opinions prepared by host party 32 itself or its agents. Thus, host party 32 can be both a host of patent-related information and a submitter of patent-related information.

Additionally, third party 26 may seek patent invalidity information regarding a patent not identified in the invalidity database. In that case, host party 32 can store identifying information for all patents that third party 26, and other parties, desire to have invalidated and then transmit that information to other parties in response to a request. Thus, website 60 can provide access to a database of available patent invalidity information as well as another database of patents sought to be invalidated.

The system and corresponding method of the present invention can have numerous benefits and advantages. First party 14 and second party 20 can receive income from patent invalidity information that might otherwise provide no direct income. This can be done while still limiting disclosure of information deemed confidential. Third party 26 can obtain patent invalidity information that it may otherwise be unable to discover, or at least obtain the patent invalidity information with less effort and/or expense. This can also be done while limiting disclosure of information third party 26 deems confidential. By providing a website and service that is convenient, that is efficient, and that allows for protection of confidential information, host party 32 can attract customers that may otherwise be unwilling to participate. Providing improved access to information on invalid patents is a benefit to the public at large, helping to prevent invalid patents from impeding technological development, and consequently, increasing confidence in those patents that are valid. Thus, the present invention supports and benefits the overall patent system.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, though some steps of method 100 are necessarily performed via a computer, certain portions of method 100 can be performed by a computer or manually. Moreover, the method is not limited to only first, second, and third parties, but can include a substantially larger number of participating parties.

1. A method for receiving, storing, and transmitting patent-related information, the method comprising:
receiving, from a plurality of sources, identifying information that at least partially identifies patent invalidity information for a plurality of patents;
storing the identifying information in a database;
receiving a request from a third party to transmit at least a portion of the identifying information over the internet; and
transmitting the requested portion of the identifying information over the internet, in a format suitable to be displayed as a website, to the third party in response to the request.

2. The method of claim 1, wherein the patent invalidity information comprises a plurality of documents stating at least one claim of one or more patents to be invalid, expired or unenforceable.

3. The method of claim 2, wherein the plurality of patents are deemed valid and in force by a patent office.

4. The method of claim 2, wherein the identifying information includes patent numbers for the plurality of patents to which the patent invalidity information relates.

5. The method of claim 1, and further comprising:
receiving contact information from the plurality of sources, wherein the contact information is kept confidential, and wherein the identifying information is publically available upon request.

6. The method of claim 1, wherein a computer performs each method step.

7. The method of claim 1, wherein the identifying information is transmitted to the third party in a format suitable to be displayed on a computer monitor as a website.

8. The method of claim 1, and further comprising:
indexing the identifying information stored in the database by patent number.

9. The method of claim 1, wherein the request from the third party is a request for identifying information that relates to a specific patent.

10. A system for receiving, storing, and transmitting patent-related information, comprising:
means for receiving first identifying information from a first party having first patent invalidity information, wherein the first identifying information at least partially identifies the first patent invalidity information;
means for receiving second identifying information from a second party having second patent invalidity information, wherein the second identifying information at least partially identifies the second patent invalidity information;
means for storing the first and second identifying information in a database; and
means for transmitting at least one of the first and second identifying information in response to a request from a third party for at least one of the first and second identifying information.

11. The system of claim 10, and further comprising:
means for receiving a purchase request from the third party to purchase the first patent invalidity information from the first party; and
means for transmitting third party contact information to the first party in response to the purchase request.

12. The system of claim 10, wherein the first patent invalidity information comprises a first patent invalidity opinion prepared by a first attorney stating at least one claim of a first patent to be invalid, expired or unenforceable, and wherein the second patent invalidity information comprises a second patent invalidity opinion prepared by a second attorney stating at least one claim of a second patent to be invalid, expired or unenforceable.

13. The system of claim 12, wherein the first patent is deemed valid and in force by a first patent office of a first country and wherein the second patent is deemed valid and in force by a second patent office of a second country.

14. The system of claim 10, and further comprising:
means for receiving first contact information from the first party and second contact information from the second party, wherein the first and second contact information are kept confidential absent agreement by the first or second party to release their respective contact information, and wherein the first and second identifying information are publically available upon request.

15. The system of claim 10, wherein the means for transmitting at least one of the first and second identifying information transmits the at least one of the first and second identifying information in a format suitable to be displayed on a computer monitor as a website.

16. The system of claim 10, wherein the system is a computer server and wherein each means comprises one or both of a processor and computer storage media.

17. A system for receiving, storing, and transmitting patent-related information, comprising:
at least one computer storage media operable to store first identifying information from a first party having first patent invalidity information and to store second identifying information from a second party having second patent invalidity information, wherein the first identifying information at least partially identifies the first patent invalidity information and wherein the second identifying information at least partially identifies the second patent invalidity information; and
at least one processor operable to receive a request from a third party for at least one of the first and second identifying information and to transmit at least one of the first and second identifying information to the third party in response to the request.

18. The system of claim 17, wherein the at least one processor is operable to transmit the at least one of the first and second identifying information in a format suitable to be displayed on a computer monitor as a website.

19. The system of claim 17, wherein the first patent invalidity information comprises a first patent invalidity opinion prepared by a first attorney stating at least one claim of a first patent to be invalid, expired or unenforceable, and wherein the second patent invalidity information comprises a second patent invalidity opinion prepared by a second attorney stating at least one claim of a second patent to be invalid, expired or unenforceable.

20. The system of claim 19, wherein the first patent is deemed valid and in force by a first patent office of a first country and wherein the second patent is deemed valid and in force by a second patent office of a second country.
